(19) United States
(12) Patent Application Publication
(10) Pub. No.: US 2026/0098177 A1
(43) Pub. Date: Apr. 9, 2026

(54) POWDER COMPOSITION BASED ON AT LEAST ONE FLUOROPOLYMER AND AT LEAST ONE HYDROPHILIC POLYMER FOR A SEPARATOR COATING

(71) Applicant: Arkema France, Colombes (FR)

(72) Inventors: Francois BEAUME, Pierre-Benite (FR); Samuel DEVISME, Serquigny (FR); Thomas FINE, Colombes (FR)

(21) Appl. No.: 19/108,807

(22) PCT Filed: Sep. 8, 2023
(86) PCT No.: PCT/FR2023/051356

§ 371 Date: Mar. 5, 2025

(30) Foreign Application Priority Data
Sep. 9, 2022 (FR) FR2209040

(51) Int. Cl. C09D 127/16; C09D 5/03; H01G 11/52; H01M 8/0221; H01M 10/0525; H01M 50/426

(52) U.S. Cl. CPC C09D 127/16; C09D 5/031; H01G 11/52; H01M 8/0221; H01M 10/0525; H01M 50/426

(57) ABSTRACT

The present invention relates to a composition comprising a polymer P1 comprising monomer units derived from vinylidene fluoride and optionally a comonomer M1 compatible with vinylidene fluoride and a polymer P2 comprising monomer units derived from a monomer M2 of formula R¹R²C═C(R³)C(O)R, in which the substituents R¹, R² and R³ are independently selected from the group consisting of H and a C₁-C₅ alkyl; R is selected from the group consisting of —NHC(CH₃)₂CH₂C(O)CH₃ or —OR′, where R′ is selected from the group consisting of H and a C₁-C₁₈alkyl optionally substituted by one or more —OH groups or a five- or six-membered heterocycle comprising at least one nitrogen atom in its cyclic chain, characterised in that the crystallisation temperature of the composition is Tc<−3.7496x+130, where x is the content, by weight, of the comonomer M1 relative to the total weight of the polymer P1, and in that the composition is in powder form.

### TECHNICAL FIELD

The present invention relates generally to the field of electrical energy storage in rechargeable secondary batteries of the Li-ion type. More specifically, the invention relates to a composition that can be used as a separator coating.

### TECHNOLOGICAL BACKGROUND OF THE INVENTION

Lithium-ion batteries also include a separator arranged between the cathode and the anode. Separators must have low thicknesses, sufficient mechanical strength and temperature resistance, good electrochemical resistance to the voltages to which they are exposed, optimum affinity for the electrolyte and more generally allow excellent ion conductivity. Polyvinylidene fluoride (PVDF) and derivatives thereof are advantageous as polyolefin separator coatings because of their electrochemical stability and their high dielectric constant, which promotes ion dissociation and thus conductivity. US 2015/0155539 discloses separators based on PVDF copolymers to which side chains including hydrophilic units are grafted.

There is still a need to develop novel coatings for separators that are easy to use and have a good compromise between dry adhesion, wet adhesion, ion conductivity and heat stability.

The invention is thus directed toward overcoming at least one of the drawbacks of the prior art.

### SUMMARY OF THE INVENTION

According to a first aspect, the present invention provides a composition comprising a polymer P1 comprising monomer units derived from vinylidene fluoride and optionally from a vinylidene fluoride-compatible comonomer M1 and a polymer P2 comprising monomer units derived from a monomer M2 of formula R¹R²C═C(R³)C(O)R in which the substituents R¹, R² and R³ are, independently of each other, selected from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its ring chain, characterized in that the crystallization temperature of said composition is Tc<−3.7496x+130 with x being the mass content of comonomer M1 based on the total weight of said polymer P1 and in that said composition is in the form of a powder. The crystallization temperature Tc is determined according to the standard ASTM D3418.

The present invention provides a composition having a good compromise between different properties such as adhesion, conductivity and thermal stability when used in the implementation of separator compositions. In particular, the production of a composition whose crystallization temperature complies with the above equation allows the desired properties to be achieved. In certain cases, said composition may not have a crystallization temperature that can be measured by DSC in accordance with the standard ASTM D3418; these compositions are included in the compositions according to the present invention since the crystallization temperature is considered to be zero. This type of composition may be obtained with a high mass content of comonomer M1 in said polymer P1, for example greater than 20% by weight based on the total weight of said polymer P1.

According to a preferred embodiment, the particles of said composition have an average diameter of from 1 to 100 μm, preferably from 5 to 75 μm, more preferentially from 5 to 50 μm.

According to a preferred embodiment, the mass ratio P1/P2 ranges from 95/5 to 5/95, advantageously from 95/5 to 25/75, preferably from 95/5 to 40/60, in particular from 95/5 to 50/50.

According to a preferred embodiment, said polymer P1 is selected from the group consisting of vinylidene fluoride homopolymers and copolymers based on vinylidene fluoride and at least one comonomer M1 that is compatible with vinylidene fluoride.

According to a preferred embodiment, said at least one comonomer M1 that is compatible with vinylidene fluoride is selected from the group consisting of vinyl fluoride, tetrafluoroethylene, hexafluoropropylene, trifluoroethylene, chlorotrifluoroethylene, trifluoropropenes, tetrafluoropropenes, hexafluoroisobutylene, perfluorobutylethylene, pentafluoropropenes, perfluoroalkylvinyl ethers, bromotrifluoroethylene, chlorofluoroethylene, chlorotrifluoroethylene, chlorotrifluoropropene and ethylene or a mixture thereof.

According to a preferred embodiment, said polymer P1 comprises monomer units bearing at least one of the following functions selected from the group consisting of carboxylic acid, carboxylic acid anhydride, carboxylic acid esters, epoxy, amide, hydroxyl, carbonyl, mercapto, sulfide, oxazoline, phenolic, ester, ether, siloxane, sulfonic, sulfuric, phosphoric, or phosphonic groups; preferably monomer units bearing at least one of the following functions selected from the group consisting of carboxylic acid, carboxylic acid anhydride, carboxylic acid esters, hydroxyl, carbonyl and mercapto.

According to a preferred embodiment, said polymer P2 contains monomer units derived from a monomer selected from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, hydroxyethyl methacrylate, hydroxyethyl acrylate, acrylic acid, methacrylic acid, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and mixtures thereof.

According to a preferred embodiment, the crystallization temperature of said composition is Tc<−3.7496x+128 with x being the mass content of comonomer M1 based on the total weight of said polymer P1. According to another aspect, the present invention provides a separator for an electrochemical device chosen from the group: Li-ion, capacitor, electric double-layer capacitor, and fuel cell membrane electrode assembly (MEA), said separator comprising a porous support and said composition according to the present invention.

According to a preferred embodiment, said composition has a mass ratio P1/P2 ranging from 95/5 to 5/95.

According to another aspect, the present invention provides an Li-ion secondary battery comprising an anode, a cathode and a separator, in which said separator is according to the present invention.

### DETAILED DESCRIPTION OF THE INVENTION

### Composition

According to a first aspect of the present invention, a composition comprising a polymer P1 and a polymer P2 is provided. Said polymer P1 is a fluoro polymer, i.e. a polymer comprising monomer units containing at least one fluorine atom. Said polymer P2 is a polymer comprising monomer units containing at least one hydrophilic group. Said polymers P1 and P2 may be in a crosslinked or non-crosslinked form and may be linear or branched.

According to a preferred embodiment, the composition comprising said polymers P1 and P2 and having a crystallization temperature as defined in the present invention makes it possible to achieve good compromises in the targeted properties as a function of the applications in which the composition is used. Thus, when the composition is used in a separator, it allows a good compromise between dry adhesion and solvent resistance, as is demonstrated in the present patent application.

Advantageously, the properties targeted above are obtained when the crystallization temperature of said composition is Tc<−3.7496x+128 with x being the comonomer M1 mass content based on the total weight of said polymer P1. Preferably, the crystallization temperature of said composition is Tc<−3.7496x+126 with x being the comonomer M1 mass content based on the total weight of said polymer P1. More preferentially, the crystallization temperature of said composition is Tc<−3.7496x+124 with x being the comonomer M1 mass content based on the total weight of said polymer P1. In particular, the crystallization temperature of said composition is Tc<−3.7496x+122 with x being the comonomer M1 mass content based on the total weight of said polymer P1. More particularly, the crystallization temperature of said composition is Tc<−3.7496x+120 with x being the comonomer M1 mass content based on the total weight of said polymer P1. In a preferred manner, the crystallization temperature of said composition is Tc<−3.7496x+118 with x being the comonomer M1 mass content based on the total weight of said polymer P1. In an advantageously preferred manner, the crystallization temperature of said composition is Tc<−3.7496x+116 with x being the comonomer M1 mass content based on the total weight of said polymer P1. In a preferentially preferred manner, the crystallization temperature of said composition is Tc<−3.7496x+115 with x being the comonomer M1 mass content based on the total weight of said polymer P1.

Preferably, in the composition, the mass ratio between polymer P1 and polymer P2 ranges from 95/5 to 5/95, advantageously from 95/5 to 25/75, preferably from 95/5 to 40/60, more preferentially from 95/5 to 50/50, in particular from 95/5 to 60/40, more preferably from 90/10 to 65/35.

Unless otherwise mentioned, the contents indicated are expressed on a weight basis. For all the indicated ranges, the limits are included unless otherwise indicated.

### i) Polymer P1

Preferably, said polymer P1 is based on a vinylidene fluoride monomer (CF₂=CH₂ or VDF), i.e. it comprises monomer units derived from vinylidene fluoride. Said polymer P1 may also be denoted by the abbreviation PVDF.

According to one embodiment, polymer P1 is a vinylidene fluoride homopolymer. In this case, x is equal to 0 and the crystallization temperature of said composition is less than 130° C.

According to another embodiment, polymer P1 is a copolymer of vinylidene fluoride with at least one comonomer M1 that is compatible with vinylidene fluoride. The comonomers M1 that are compatible with vinylidene fluoride may be halogenated (fluorinated, chlorinated or brominated) or non-halogenated. Examples of suitable fluorinated comonomers M1 are: vinyl fluoride, tetrafluoroethylene, hexafluoropropylene, trifluoroethylene, chlorotrifluoroethylene, trifluoropropenes and notably 3,3,3-trifluoropropene, tetrafluoropropenes and notably 2,3,3,3-tetrafluoropropene or 1,3,3,3-tetrafluoropropene, hexafluoroisobutylene, perfluorobutylethylene, pentafluoropropenes and notably 1,1,3,3,3-pentafluoropropene or 1,2,3,3,3-pentafluoropropene, perfluoroalkyl vinyl ethers and notably those of general formula Rf—O—CF=CF₂, Rf being an alkyl group, preferably of C₁-C₄ (preferred examples being perfluoropropyl vinyl ether and perfluoromethyl vinyl ether).

The fluorinated comonomer may include a chlorine or bromine atom. It may in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

The polymer P1 preferably contains at least 50 mol % of vinylidene fluoride, advantageously at least 60 mol % of vinylidene fluoride, preferably at least 70 mol % of vinylidene fluoride. The comonomer M1 may be present in a content of from 1% to 50%, advantageously from 2% to 30% by weight relative to the weight of said polymer P1.

According to one embodiment, polymer P1 is a copolymer of vinylidene fluoride (VDF) and hexafluoropropylene (HFP) (P(VDF-HFP)), having a weight percentage of hexafluoropropylene monomer units of from 2% to 30%, advantageously from 2% to 25%, preferably from 2% to 20%, preferably from 4% to 15% by weight relative to the weight of said polymer P1. According to another embodiment, polymer P1 is a copolymer of vinylidene fluoride (VDF) and hexafluoropropylene (HFP) (P(VDF-HFP)), having a weight percentage of hexafluoropropylene monomer units of from 20% to 30%, advantageously from 20% to 25% by weight relative to the weight of said polymer P1.

According to one embodiment, polymer P1 is a copolymer of vinylidene fluoride and of tetrafluoroethylene (TFE).

According to one embodiment, polymer P1 is a copolymer of vinylidene fluoride and of chlorotrifluoroethylene (CTFE).

According to one embodiment, polymer P1 is a VDF-TFE-HFP terpolymer. According to one embodiment, polymer P1 is a VDF-TrFE-TFE terpolymer (TrFE being trifluoroethylene). In these terpolymers, the mass content of VDF is at least 10%, the comonomers being present in variable proportions.

According to one embodiment, polymer P1 comprises monomer units bearing at least one of the following functions: carboxylic acid, carboxylic acid anhydride, carboxylic acid esters, epoxy (such as glycidyl), amide, hydroxyl, carbonyl, mercapto, sulfide, oxazoline, phenolic, ester, ether, siloxane, sulfonic, sulfuric, phosphoric, phosphonic groups. The function is introduced via a chemical reaction which may be grafting, or copolymerization of the vinylidene fluoride (VDF) monomer with a monomer bearing at least one of said functional groups and a vinyl function that is capable of copolymerizing with the VDF monomer, via techniques well known to those skilled in the art, or by adsorption of a polymer bearing the functionality into polymer P1. Thus, preferably, said monomer units are derived from a polymer comprising them and having a molar mass of less than 100 000 g/mol, preferably less than 50 000 g/mol, in particular less than 20 000 g/mol. The latter may be grafted onto or adsorbed by said polymer P1.

According to one embodiment, the functional group bears a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate. Thus, said polymer P1 may comprise monomer units derived from a monomer selected from the group consisting of acrylic acid, methacrylic acid, methyl acrylate, methyl methacrylate, hydroxyethyl methacrylate, hydroxypropyl methacrylate and hydroxyethylhexyl methacrylate.

According to one embodiment, the units bearing the carboxylic acid function also comprise a heteroatom chosen from oxygen, sulfur, nitrogen and phosphorus.

According to one embodiment, the functionality is introduced via the transfer agent used during the synthetic process. Preferably, the transfer agent is a polymer with a molar mass of less than or equal to 20 000 g/mol and bearing functional groups chosen from: carboxylic acid, carboxylic acid anhydride, carboxylic acid esters, epoxy (such as glycidyl), amide, hydroxyl, carbonyl, mercapto, sulfide, oxazoline, phenolic, ester, ether, siloxane, sulfonic, sulfuric, phosphoric, phosphonic groups; preferably carboxylic acid, carboxylic acid anhydride, carboxylic acid esters. An example of a transfer agent of this type is oligomers of acrylic acid. The transfer agent may be grafted onto or adsorbed by polymer P1.

Said polymer P1 may comprise end groups formed from said transfer agent. In particular, the transfer agent is a polymer with a molar mass of less than or equal to 20 000 g/mol and bearing functional groups selected from the group consisting of carboxylic acid or carboxylic acid ester. The molar mass of the transfer agent may be determined by GPC analysis performed on Waters 2695e equipment coupled with a Wyatt Wyatt NEON refractometer fitted with two PL Gel mixed C columns and a guard column (7.8 mm I.D.×30 cm, 5 μm) under the following conditions: temperature: 35° C.; flow rate: 1.0 mL/min; injection volume: 100 μL; concentration 1 mg/mL in THF (HPLC grade); calibration using 12 samples of poly(methyl methacrylate) from 535 to 2 210 000 g/mol.

The functional group content of said polymer P1 is at least 0.01 mol %, preferably at least 0.1 mol %, and not more than 15 mol %, preferably not more than 10 mol %.

Polymer P1 preferably has a high molecular weight. The term “high molecular weight”, as used here, is understood to mean a polymer P1 having a melt viscosity of greater than 100 Pa·s, preferably of greater than 500 Pa·s, more preferably of greater than 1000 Pa·s, according to the ASTM D-3835 method, measured at 232° C. and 100 sec⁻¹.

According to one embodiment, polymer P1 bearing functional groups can undergo crosslinking either by self-condensation of its functional groups or by reaction with a catalyst and/or a crosslinking agent, such as melamine resins, epoxy resins and the like, and also known crosslinking agents of low molecular weight, such as di- or higher polyisocyanates, polyaziridines, polycarbodiimides, polyoxazolines, dialdehydes, such as glyoxal, acetoacetates, malonates, acetals, thiols and acrylates which are di- and trifunctional, cycloaliphatic epoxy molecules, organosilanes, such as epoxysilanes and aminosilanes, carbamates, diamines and triamines, inorganic chelating agents, such as certain zinc and zirconium salts, titaniums, glycourils and other aminoplasts. In certain cases, functional groups originating from other polymerization ingredients, such as surfactants, initiators or seed particles, can be involved in the crosslinking reaction. When two or more functional groups are involved in the crosslinking process, the pairs of complementary reactive groups are, for example, hydroxyl-isocyanate, acid-epoxy, amine-epoxy, hydroxyl-melamine, acetoacetate-acid. The acrylate and/or methacrylate monomers not containing functional groups capable of participating in crosslinking reactions after the polymerization should preferably represent 70% or more by weight of the total mixture of monomers and more preferably should be greater than 90% by weight. According to one embodiment, polymer P1 comprises a crosslinking agent chosen from the group consisting of isocyanates, diamines, adipic acid, dihydrazides and combinations thereof.

According to certain embodiments, the PVDF homopolymer and the VDF copolymers are composed of biobased VDF. The term “biobased” means “derived from biomass”. This makes it possible to improve the ecological footprint of the separator. Biobased VDF may be characterized by a content of renewable carbon, that is to say of carbon of natural origin originating from a biomaterial or from biomass, of at least 1 at %, as determined by the content of ¹⁴C according to the standard NF EN 16640. The term “renewable carbon” indicates that the carbon is of natural origin and originates from a biomaterial (or from biomass), as indicated below. According to certain embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

The P1 homopolymers and VDF copolymers used in the invention may be obtained via known polymerization methods such as emulsion or suspension polymerization.

According to one embodiment, they are prepared by an emulsion polymerization process in the absence of a fluorinated surfactant.

The polymerization of the vinylidene fluoride preferably results in a latex generally having a solids content of from 10% to 60% by weight, preferably from 10% to 50%, and having a weight-average particle size of less than 1 micrometre, preferably less than 1000 nm, preferably less than 800 nm and more preferably less than 600 nm. The weight-average size of the particles is generally at least 20 nm, preferably at least 50 nm, and advantageously the average size is within the range from 100 to 400 nm. The polymer particles can form agglomerates, the weight-average size of which is from 1 to 30 micrometres and preferably from 2 to 20 micrometres. The agglomerates can break up into discrete particles during the formulation and the application to a substrate.

### ii) Polymer P2

As mentioned above, said polymer P2 comprises monomer units resulting from a monomer M2 of formula R¹R²C═C(R³)C(O)R in which the substituents R¹, R² and R³ are selected, independently of each other, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a 5- or 10-membered heterocycle comprising at least one nitrogen atom in its ring chain. Said heterocycle may be saturated or unsaturated or aromatic. Said heterocycle may be monocyclic or bicyclic. Said heterocycle may be a pyrrole, pyrrolidine, pyridine, piperidine, pyrimidine, pyrazine, 1,4-dihydropyridine, indole, oxindole, isatin, quinoline, isoquinoline, quinazoline, imidazoline, pyrazolidine, 2-pyrrolidone, delta-lactam, succinimide, 2-imidazolidinone or 4-imidazolidinone ring. Said heterocycle may be substituted with one or more C₁-C₅ alkyl groups. As mentioned above, the C₁-C₁₈ alkyl is optionally substituted with said heterocycle. The latter may be bonded to the alkyl chain via the nitrogen atom or any other atoms forming the heterocycle. Preferably, the heterocycle is 2-pyrrolidone, delta-lactam, succinimide, 2-imidazolidinone or 4-imidazolidinone.

Preferably, said polymer P2 comprises monomer units resulting from an alkyl (meth)acrylate monomer M2 of formula R¹R²C═C(R³)C(O)R in which the substituents R¹, R² and R³ are selected, independently of each other, from the group consisting of H and C₁-C₅ alkyl; R is selected from the group consisting of —NHC(CH₃)₂CH₂C(O)CH₃ or —OR′ with R′ selected from the group consisting of C₁-C₁₈ alkyl optionally substituted with one or more —OH groups or a 5- or 10-membered heterocycle comprising at least one nitrogen atom in its ring chain. Said polymer P2 comprises monomer units derived from an alkyl (meth)acrylate monomer M2 of formula R¹R²C═C(R³)C(O)R in which the substituents R¹, R² and R³ are, independently of each other, selected from the group consisting of H and C₁-C₅ alkyl; R is —OR′ with R′ selected from the group consisting of H and C₁-C₁₃ alkyl optionally substituted with one or more —OH groups. Preferably, the heterocycle is as defined above; in particular, the heterocycle is 2-pyrrolidone, delta-lactam, succinimide, 2-imidazolidinone or 4-imidazolidinone. The term “alkyl (meth)acrylate” refers to alkyl acrylates and alkyl methacrylates.

According to a preferred embodiment, the substituent R′ is selected from the group consisting of H, methyl, ethyl, propyl, n-butyl, isobutyl, t-butyl, n-dodecyl, amyl, isoamyl, hexyl, 2-ethylhexyl, lauryl, n-octyl, hydroxyethyl, hydroxybutyl, hydroxypropyl and ethyl, substituted with a ureido, hydroxyethyl, hydroxypropyl or hydroxybutyl group.

In particular, said polymer P2 comprises monomer units derived from an alkyl (meth)acrylate monomer M2 of formula R¹R²C═C(R³)C(O)R in which the substituents R¹ and R² are H; R³ is H or CH₃; R is —OR′ with R′ selected from the group consisting of H, methyl, ethyl, propyl, n-butyl, isobutyl, t-butyl, hydroxyethyl, hydroxypropyl, hydroxybutyl, 2-pyrrolidone, delta-lactam, succinimide, 2-imidazolidinone and 4-imidazolidinone.

Thus, the alkyl (meth)acrylate may be methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, hydroxyethyl methacrylate, hydroxyethyl acrylate, acrylic acid, methacrylic acid, methyl acrylic acid, methyl methacrylate, ureido methacrylate and mixtures thereof. Among these, the alkyl acrylates with an alkyl group containing from 1 to 8 carbon atoms are preferred, and the alkyl acrylates with an alkyl group containing from 1 to 5 carbon atoms are more preferable. These compounds may be used alone or as a mixture of two or more. Thus, said polymer P2 may be a homopolymer of a monomer M2 as defined above or a copolymer derived from a mixture of one or more monomers M2 as defined above.

The term “acrylate” here comprises acrylates and methacrylates.

The optional ethylenically unsaturated compound which is copolymerizable with the alkyl acrylate and the alkyl methacrylate comprises:
(A) an alkenyl compound containing a functional group, and
(B) an alkenyl compound without a functional group.

The alkenyl compound (A) containing a functional group comprises, for example, α,β-unsaturated carboxylic acids such as acrylic acid, methacrylic acid, fumaric acid, crotonic acid, itaconic acid and the like; vinyl ester compounds such as vinyl acetate, vinyl neodecanoate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, n-dodecyl acrylate, fluoroalkyl acrylate and the like; and methacrylic acid esters such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or as a mixture of two or more.

The alkenyl compound without a functional group (B) comprises, for example, conjugated dienes, such as 1,3-butadiene, isoprene and the like; divinyl hydrocarbon compounds, such as divinylbenzene and the like; and alkenyl cyanides, such as acrylonitrile, methacrylonitrile and the like. Among these, the preferred compounds are 1,3-butadiene and acrylonitrile. These compounds may be used alone or as a mixture of two or more.

It is preferable for the functional alkenyl compound (A) to be used in a proportion of less than 50% by weight, with respect to the weight of the mixture of monomers, and for the alkenyl compound without a functional group (B) to be used in a proportion of less than 30% by weight, with respect to the weight of the mixture of monomers.

### Process for Preparing the Composition

Said composition according to the present invention may be prepared via a process comprising the steps of:
a) Providing a reactor containing said polymer P1 comprising monomer units derived from vinylidene fluoride,
b) Adding at least one monomer M2 of formula R¹R²C═C(R³)C(O)R as defined in the present patent application to said reactor and placing said polymer P1 in contact with said at least one monomer M2 for at least 5 minutes;
c) Performing the polymerization of said at least one monomer M2 to form a composition comprising said polymer P1 and the polymer P2 as defined in the present application;
d) Drying and optionally milling the composition obtained in step c) to prepare said composition according to the present invention.

Said polymer P1 is preferably in the form of a latex.

During step b), at least one monomer M2 of formula R¹R²C═C(R³)C(O)R as defined in the present patent application is added to said reactor. During step b), preferably all the constituent monomers of the polymer P2 are added, if the latter contains different monomer units of formula R¹R²C═C(R³)C(O)R. The addition of all of said at least one constituent monomer M2 of the polymer P2 in step b) allows the intimacy of mixing between the polymer P1 and all of the constituent monomer units of the polymer P2 to be improved. Preferably, said at least one monomer M2 is selected from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxybutyl acrylate, hydroxypropyl methacrylate, hydroxyethyl methacrylate, hydroxyethyl acrylate, acrylic acid, methacrylic acid, methyl acrylic acid, methyl methacrylate, ureido methacrylate and combinations thereof. Step b) may optionally also comprise the addition of an alkenyl compound (A) and/or (B) as described above in relation to polymer P2.

During step b), polymer P1 and said at least one monomer M2 are placed in contact for a sufficiently long time to allow said monomer M2 to impregnate the particles of the polymer P1 before polymerization thereof is performed. This contact time is at least 5 minutes, preferably 10 minutes, in particular at least 15 minutes, more particularly at least 20 minutes. Preferably, monomer M2 is added before the initiator. This allows the preferred compositions of the present invention to be obtained.

Said process also comprises a step c) during which said at least one monomer M2 is polymerized. Step c) is preferably performed in the presence of water. Step c) of polymerization of said at least one monomer M2 is performed in the presence of an initiator. Said initiator may be an initiator of the persulfate type such as sodium persulfate, potassium persulfate, barium persulfate or ammonium persulfate; alkali metal bisulfites; peroxides such as benzoyl peroxide or dicumyl peroxide; hydroperoxides such as methyl hydroperoxide or tert-butyl hydroperoxide; acyloins such as benzoin; peracetates such as methyl peracetate or tert-butyl peracetate; perbenzoates such as tert-butyl perbenzoate; peroxalates such as dimethyl peroxalate or di(tert-butyl) peroxalate; azo compounds such as azobisisobutyronitrile or dimethyl azobisisobutyrate. The initiator is preferably added in a content of from 0.005% to 1% by weight based on the weight of said at least one monomer M2 and optionally of said alkenyl compounds (A) and (B) if present.

Optionally, step c) is performed in the presence of a chain-transfer agent. The chain-transfer agent may be an oxygen-containing compound such as an alcohol, carbonate, ketone, ester or ether; a halocarbon or hydrohalocarbon compound such as chlorocarbons, hydrochlorocarbons, chlorofluorocarbons or hydrochlorofluorocarbons; ethane or propane. Alternatively, the chain-transfer agent may be a polymer with a molar mass of less than or equal to 20 000 g/mol and bearing functional groups chosen from the following groups: carboxylic acid, carboxylic acid anhydride, carboxylic acid esters, epoxy (such as glycidyl), amide, hydroxyl, carbonyl, mercapto, sulfide, oxazoline, phenolics, ester, ether, siloxane, sulfonic, sulfuric, phosphoric and phosphonic groups. An example of a transfer agent of this type is oligomers of acrylic acid. Preferably, if it is present, the chain-transfer agent is added in a content of from 0.05% to 5% by weight based on the weight of said at least one monomer M2 and optionally of said alkenyl compounds (A) and (B) if present.

Other compounds may also be present in the implementation of said composition according to the present process as mentioned in the protocol described in WO 2007/018783.

Step c) may be performed at a temperature of from 20° C. to 160° C. Step c) may be performed at a pressure of from 280 to 20 000 kPa.

Preferably, steps b) and c) are performed with stirring.

Said composition obtained in step c) is preferably obtained in the form of a latex, i.e. in the form of a dispersion in an aqueous medium. Thus, said composition is an aqueous dispersion obtained by emulsion polymerization of 5 to 100, preferably 5-95 parts by weight of a monomer mixture containing at least one monomer M2 chosen from the group consisting of alkyl acrylates whose alkyl groups contain 1-18 carbon atoms and alkyl methacrylates whose alkyl groups contain 1-18 carbon atoms and optionally an ethylenically unsaturated compound that is copolymerizable with alkyl acrylates and alkyl methacrylates, in an aqueous medium in the presence of 100 parts by weight of particles of a polymer P1 as defined above. The particles of polymer P1 serve as seeds for the polymerization of the monomers M2. The particles of polymer P1 may be added in any state to the polymerization system, as long as they are dispersed in an aqueous medium in the form of particles. As polymer P1 is generally produced in the form of an aqueous dispersion, it is convenient that the aqueous dispersion as produced is used as seed particles.

The product of the polymerization obtained in step c) is dried in step d). The drying step may be performed by spraying or co-spraying, preferably at a temperature of from 100° C. to 220° C. The powder may also be obtained by milling techniques, such as cryomilling, where the mixture is brought to a temperature below ambient temperature, by means of liquid nitrogen for example, prior to milling. At the end of the step of producing the powder, namely after the drying step, the particle size may be adjusted and optimized by selection or screening processes and/or by milling. In the composition obtained in step d), the average diameter of the particles is from 1 to 100 μm, preferably from 5 to 75 μm, more preferentially from 5 to 50 μm. The average diameter of the particles is determined by laser particle size analysis using a Malvern INSITEC System analyzer. The measurement is carried out by laser diffraction on a powder with a focal length of 100 mm. In said composition, the P1 and P2 polymer chains are entangled to form an interpenetrated polymer network (IPN) as defined by the IUPAC; which is different from a mixture of preformed polymers. Preferably, the P1 and P2 polymer chains are entangled to form a sequential interpenetrated polymer network as defined by the IUPAC.

### Separator

Said composition according to the present invention may be used as one of the materials for the preparation of a separator in an electrochemical device. In this application, the mass ratio P1/P2 preferably ranges from 95/5 to 5/95, in particular from 95/5 to 40/60, more preferably from 90/10 to 50/50. Preferably, polymer P1 is a copolymer of vinylidene fluoride and of at least one comonomer that is compatible therewith as described above. In particular, polymer P1 may be a copolymer of vinylidene fluoride (VDF) and hexafluoropropylene (HFP) (P(VDF-HFP)), with a weight percentage of hexafluoropropylene monomer units of from 2% to 30%, advantageously from 2% to 25%, preferably from 2% to 20% by weight relative to the weight of polymer P1; or a copolymer of vinylidene fluoride and tetrafluoroethylene (TFE); or a copolymer of vinylidene fluoride and chlorotrifluoroethylene (CTFE); or a VDF-TFE-HFP terpolymer as described above. Also, said polymer P1 may comprise monomer units selected from the group consisting of acrylic acid, methacrylic acid, methyl acrylate, methyl methacrylate, hydroxyethyl methacrylate, hydroxypropyl methacrylate and hydroxyethylhexyl methacrylate.

Said composition is preferably used in the separator coating. In addition to said composition, the separator coating may contain inorganic particles which serve to form micropores in the coating (the interstices between inorganic particles). The addition of inorganic particles can also contribute to the heat resistance or improve the wettability. According to one embodiment, said coating comprises from 50% to 99% by weight of inorganic particles, relative to the weight of the coating. These inorganic particles must be electrochemically stable (not subject to oxidation and/or to reduction within the range of voltages which are used). In addition, the pulverulent inorganic materials preferably have a high ionic conductivity.

Low-density materials are preferred to materials of higher density, since the weight of the battery produced can be reduced. The dielectric constant is preferably equal to or greater than 5. According to one embodiment, said inorganic particles are chosen from the group consisting of: BaTiO₃, Pb(Zr,Ti)O₃, Pb₁₋ₓLaₓZr_{y}O₃ (0<x<1, 0<y<1), PbMg₃Nb_{2/3})₃, PbTiO₃, hafnia (HfO (HfO₂)), SrTiO₃, SnO₂, CeO₂, MgO, NiO, CaO, ZnO, Y₂O₃, boehmite (γ-AIO(OH)), Al₂O₃, TiO₂, SiC, ZrO₂, boron silicate, BaSO₄, nanoclays or mixtures thereof. In this case, the ratio of the solids of the polymer P1 and P2 to the inorganic particles is from 0.5 to 40 parts by weight of solids of the polymer P1 and P2 per 60 to 99.5 parts by weight of inorganic particles. Advantageously, the ratio of the solids of the polymer P1 and P2 to the inorganic particles is from 0.5 to 35 per 65 to 99.5 parts by weight of inorganic particles. Preferably, the ratio of the solids of the polymer P1 and P2 to the inorganic particles is from 0.5 to 30 per 70 to 99.5 parts by weight of inorganic particles. The separator coating may optionally comprise from 0% to 15% by weight, on the basis of the polymer, and preferably from 0.1% to 10% by weight of additives chosen from thickeners, pH-adjusting agents, anti-settling agents, surfactants, wetting agents, fillers, anti-foaming agents and fugitive or non-fugitive adhesion promoters. The fillers mentioned here in the additives are different from the inorganic particles mentioned above.

Said separator according to the present invention comprises a coating as described above, optionally arranged on one or both faces of a porous support. In this case, the coating is used to coat the support of a separator, on at least one face, in the form of a monolayer or of multilayers. There is no specific limitation on the choice of the support which is coated with the coating of the invention, as long as it is a porous substrate having pores. The support may comprise a single layer or several distinct layers. When it comprises several layers, the coating as described in the present invention is arranged on the external face of the support, that is to say on the face which will be first in contact with the electrolyte composition used in the battery. Advantageously, the application of the coating to the support takes place by the aqueous route or by the solvent route. The porous substrate may be in the form of a membrane or a fibrous fabric. When the porous substrate is fibrous, it may be a nonwoven web forming a porous web, such as a web obtained by direct spinning or melt blowing (of spun bond or melt blown type) or electrospinning. Examples of porous substrates that are useful in the invention as support comprise, without being limited thereto: polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalate or mixtures thereof. However, other engineering plastics which are heat-resistant may be used, without specific limitation. Nonwoven materials made of natural or synthetic materials may also be used as substrate of the separator. The porous substrate generally has a thickness of 1 to 50 μm, and is typically membranes obtained by extrusion and drawing (wet or dry processes) or cast nonwovens. The porous substrate preferably has a porosity of between 5% and 95%. The average size of the pores (diameter) is preferably of between 0.001 and 50 μm, more preferably between 0.01 and 10 μm.

According to an alternative embodiment, said separator does not comprise a porous support. In this case, said separator consists of the coating as described above and comprising said composition; it is deposited directly on the cathode or on the anode of the electrochemical device. The absence of a porous support allows the production costs of the electrochemical device and its dimensions to be limited. In this case, said coating replaces the porous support. In this embodiment, said polymer resin preferably has a porosity of from 5% to 95%. The average size of the pores of said polymer resin is preferably between 0.001 and 50 μm, more preferably between 0.01 and 10 μm.

According to another alternative embodiment, said separator does not comprise any porous support and said separator is in the form of a gel. Said separator is as described in the present patent application. Said separator is formed into the form of a gel via conventional techniques such as solvent casting or extrusion.

The separator coating of the invention has an excellent compromise of properties for separator coating application: good dry and wet adhesion, good resistance to electrolyte solvent(s) characterized by good conserved integrity and moderate swelling.

### Example

The crystallization temperature is measured by DSC during cooling, according to the following programme:
Heating from 10° C. to 200° C. at 10° C./min.
Holding for 1 min at 200° C.
Cooling from 200° C. to −80° C. at 5° C./min.

### Preparation of a Composition According to the Invention (Example 1)

Polymer P1 used in Example 1 is a latex of P(VDF-HFP) copolymer. It is used as seed to synthesize the composition according to the present patent application via an emulsion polymerization process according to the protocol described in WO 2007/018783 in the presence of a chain-transfer agent of acrylic acid oligomer type with a molar mass of less than 20 000 g/mol. In Example 1, monomer M2 used to prepare polymer P2 is a mixture of methyl (meth)acrylate, ethyl acrylate and methacrylic acid in a mass proportion of 58/40/2. The monomers M2 are placed in contact with polymer P1 for a period of 25 minutes before the polymerization of the monomers M2 is performed. The composition obtained is dried by co-spraying and milled to obtain particles having an average diameter between 10 and 25 μm measured by laser particle size analysis.

### Preparation of a Latex Mixture (Example 2—Comparative Composition)

Polymer P1 and polymer P2 are prepared independently of each other via an emulsion polymerization process. In the present example, polymer P2 is prepared in the absence of a seed of polymer P1. The two polymers in the form of a latex are then mixed in a ratio of 70/30. The composition of polymers P1 and P2 is the same as that of polymers P1 and P2 of Example 1. The composition obtained is dried by co-spraying.

### Comparative Composition of Example 3

Example 3 is performed using a composition consisting of polymer P1 in the form of the latex of Example 1.

### Preparation of the Coating Compositions

The powder indicated (100 parts) is added to the aqueous solution (900 parts) of thickening agent (CMC 250k—(4.5 parts)) and of dispersant (BYK 2055—(2 parts)), and then dispersed under high shear (Thinky mixer 2000 rpm/5 min in the presence of zirconia beads) to obtain a dispersion of fine polymer particles in water. The other additives—wetting agent (BYK 349—(1.8 parts)), adhesion promoter (BYK LPC-22346, already supplied in 50% solution (6 parts)) are then added only for the composition not already containing acrylic in the latex—and then mixing is carried out under low shear (magnetic stirrer).

### Application of the Coatings:

Each coating composition is applied to a porous separator (Celgard H2512) with a coater equipped with a spiral bar depositing 6 μm (wet thickness) at a rate of approximately 25 mm/see, and then dried at ambient temperature for 24 h.

The results are presented in table 1 below.

TABLE 1

| | % HFP | Ratio | | Dry | Wet |
|---|---|---|---|---|---|
| | in P1 | P1/P2 | | adhesion (% | adhesion (% |
| | (by | (by | Tc | vs PVDF of | vs PVDF of |
| Examples | weight) | weight) | (° C.) | example 3) | example 3) |
| 1 (Inv) | 6.8 | 70/30 | 93.4 | 205 | 212 |
| 2 (Comp.) | 6.8 | 70/30 | 106.0 | 172 | 163 |
| 3 (Comp.) | 6.8 | 100/0 | 109.2 | 100 | 100 |

The separator coating according to the invention has an excellent compromise of properties for the intended application: good dry adhesion, good resistance to electrolyte solvent(s) characterized by good conserved integrity. On the other hand, the comparative examples with a crystallization temperature higher than the value defined by the equation −3.7496x+130 show at least one very unfavourable property.

1. A composition comprising a polymer P1, said polymer P1 comprising monomer units derived from vinylidene fluoride and optionally from a vinylidene fluoride-compatible comonomer M1 and a polymer P2 comprising monomer units derived from a monomer M2 of formula R¹R²C═C(R³)C(O)R in which the substituents R¹, R² and R³ are, independently of each other, selected from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl, said C₁-C₁₈ alkyl being optionally substituted with one or more —OH groups or a five- or six-membered heterocycle comprising at least one nitrogen atom in its ring chain, characterized in that the crystallization temperature of said composition is Tc<−3.7496x+130 with x being the mass content of comonomer M1 based on the total weight of said polymer P1 and in that wherein said composition is in the form of a powder.

2. The composition of claim 1 as claimed in the preceding claim, characterized in that the particles of said composition have an average diameter of from 1 to 100 μm, preferably from 5 to 75 μm, more preferentially from 5 to 50 μm.

3. The composition of claim 1 as claimed in either one of the preceding claims, characterized in that the mass ratio P1/P2 ranges from 95/5 to 5/95, advantageously from 95/5 to 25/75, preferably from 95/5 to 40/60, in particular from 95/5 to 50/50.

4. The composition of claim 1 as claimed in either of the preceding claims, characterized in that said polymer P1 is selected from the group consisting of vinylidene fluoride homopolymers and copolymers based on vinylidene fluoride and said at least one comonomer M1 that is compatible with vinylidene fluoride.

5. The composition of claim 1 as claimed in the preceding claim, characterized in that said at least one comonomer M1 that is compatible with vinylidene fluoride is selected from the group consisting of vinyl fluoride, tetrafluoroethylene, hexafluoropropylene, trifluoroethylene, chlorotrifluoroethylene, trifluoropropenes, tetrafluoropropenes, hexafluoroisobutylene, perfluorobutylethylene, pentafluoropropenes, perfluoroalkylvinyl ethers, bromotrifluoroethylene, chlorofluoroethylene, chlorotrifluoroethylene, chlorotrifluoropropene, and ethylene or a mixture and mixtures thereof.

6. The composition of claim 1 as claimed in any one of the preceding claims, characterized in that said polymer P1 comprises monomer units bearing at least one functional group of the following functions selected from the group consisting of carboxylic acid, carboxylic acid anhydride, carboxylic acid esters, epoxy, amide, hydroxyl, carbonyl, mercapto, sulfide, oxazoline, phenolic, ester, ether, siloxane, sulfonic, sulfuric, phosphoric, or and phosphonic groups; preferably monomer units bearing at least one of the following functions selected from the group consisting of carboxylic acid, carboxylic acid anhydride, carboxylic acid esters, hydroxyl, carbonyl and mercapto.

7. The composition of claim 1 as claimed in any one of the preceding claims, characterized in that said polymer P2 contains monomer units derived from a monomer M2 selected from the group consisting of methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, hydroxyethyl methacrylate, hydroxyethyl acrylate, acrylic acid, methacrylic acid, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and mixtures thereof.

8. The composition of claim 1 as claimed in any one of the preceding claims, characterized in that the crystallization temperature of said composition is Tc<−3.7496x+128 with x being the mass content of comonomer M1 based on the total weight of said polymer P1.

9. A separator for an electrochemical device chosen from the following group: Li-ion, capacitor, electric double-layer capacitor, and fuel cell membrane electrode assembly (MEA), said separator comprising a porous support and said composition of claim 1 as claimed in any one of the preceding claims 1 to 8.

10. The separator of claim 9 as claimed in the preceding claim, characterized in that said composition has a mass ratio P1/P2 ranging from 95/5 to 5/95.

11. An Li-ion secondary battery comprising an anode, a cathode and a the separator of claim 9, in which said separator is as claimed in claim 9 or claim 10.
